(19) United States
(12) Patent Application Publication
(10) Pub. No.: US 2004/0141639 A1
(43) Pub. Date: Jul. 22, 2004

(54) Image diagnosis aid system and image diagnosis aid method

(76) Inventor: Koh Matsui, Tokyo (JP)

Correspondence Address: Cameron Kerrigan, Squire, Sanders & Dempsey L.L.P., Suite 300, One Maritime Plaza, San Francisco, CA, 94111, US

(21) Appl. No.: 10/756,223

(22) Filed: Jan. 12, 2004

(30) Foreign Application Priority Data
Jan. 17, 2003 (JP) 2003-009102

(51) Int. Cl. G06K 9/00

(52) U.S. Cl. 382/132

(57) ABSTRACT

An image diagnosis aid system has: an image storing section for storing input image data obtained by radiographing a subject; an abnormal shadow candidate detecting section for detecting one or a plurality of kinds of abnormal shadow candidates from the stored image data, and for generating abnormal shadow candidate information; an abnormal shadow candidate information storing section for storing the generated abnormal shadow candidate information; an image display section for displaying at least one of the stored image data and the stored abnormal shadow candidate information; and an image output selecting section capable of changing displaying order of the image data on the image display section based on the abnormal shadow candidate information.

### BACKGROUND OF THE INVENTION

1. Field of the Invention

The invention relates to an image diagnosis aid system and an image diagnosis aid method, in particular, an image diagnosis aid system and an image diagnosis aid method for increasing diagnosis efficiency when a doctor image-diagnoses a radiation image.

2. Description of Related Art

In a medical field, by use of a medical image radiographing apparatus such as CT (Computed Tomography), MRI (Magnetic Resonance Imaging) or the like, a patient being a subject is radiographed to generate a medical image, then the medical image is converted into digital data, and when a doctor conducts diagnosis, the medical image is displayed on an image display device such as CRT (Cathode Ray Tube) or the like for image diagnosis.

Especially in recent years, for the purpose of reducing load on a doctor for image-diagnosing and reducing oversight on abnormal shadow, a Computer Aided Diagnosis (CAD) software for detecting an abnormal shadow candidate of lung cancer, breast cancer or the like by analyzing image data with a digital image processing technique by use of a computer has been developed. With such software, nowadays it is possible to provide information of an elected abnormal shadow candidate to a doctor, to aid him diagnose.

For example, a mammogram image diagnosis aid apparatus capable of dividing a plurality of mammograms (radiation images of mammas) to be used for a breast cancer diagnosis into groups, and displaying images per each group according to predetermined displaying order has been proposed (for example, see Japanese Patent Application Publication (Unexamined) No. Tokukai 2000-287957). Thereby, a doctor can diagnose the mammograms in group order in which it is easy to image-diagnose them with comparison.

However, when diagnosis on lung cancer, breast cancer or the like is to be conducted, there are cases where a doctor needs to image-diagnose a large number of medical images at once in a group examination or the like, and give a diagnosis to them one after another. Therefore, it is problematic that doctor's diagnosis ability decreases due to his/her physical condition and fatigue. Further, information such as an image diagnosis history, a result of the computer aided diagnosis software, success or failure on computer aided diagnosis software processing or the like, is written in a clinical record, input in a personal computer, in other words, it is treated differently depending on each doctor. Therefore, data is not managed integrally, and it causes confusion to those who image-diagnose.

### SUMMARY OF THE INVENTION

The present invention is made in consideration of problems in above-mentioned conventional arts, and an object of the present invention is to provide an image diagnosis aid system and an image diagnosis aid method capable of minimizing doctor's oversight on disease at the time of image-diagnosing a large number of medical images and contributing for diagnosis efficiency increase.

In order to solve the above-mentioned problem, in accordance with a first aspect of the present invention, An image diagnosis aid system comprises: an image storing section for storing input image data obtained by radiographing a subject; an abnormal shadow candidate detecting section for detecting one or a plurality of kinds of abnormal shadow candidates from the stored image data, and for generating abnormal shadow candidate information; an abnormal shadow candidate information storing section for storing the generated abnormal shadow candidate information; an image display section for displaying at least one of the stored image data and the stored abnormal shadow candidate information; and an image output selecting section capable of changing displaying order of the image data on the image display section based on the abnormal shadow candidate information.

According to the first aspect of the present invention, since it is possible to change displaying order of image data based on abnormal shadow candidate information, it is possible to display the image data in the displaying order in which a doctor can easily image-diagnose, and thereby it is possible to contribute for diagnosis efficiency increase. In particular, since there are cases where frequency of disease and amount of images to be image-diagnosed largely differ between a general practice and a group examination, by changing the displaying order of the image data to be image-diagnosed, it is possible to reduce doctor's fatigue and increase diagnosis accuracy over large amount of image data in a group examination.

Preferably, in the system of the first aspect of the present invention, image accompanying information corresponding to the image data to be displayed is input to the image output selecting section.

According to the system, since image accompanying information accompanying the image data is input to the image output selecting section, it is possible to provide more detailed information at the time of image diagnosis.

Preferably, in the system of the first aspect of the present invention, the image output selecting section determines the displaying order of the image data on the image display section based on both the image accompanying information and the abnormal shadow candidate information.

According to the system, since it is possible to change displaying order of the image data to be image-diagnosed based on the image accompanying information, it is possible to display the image data in the displaying order in which a doctor can easily image-diagnose, and thereby it is possible to contribute for diagnosis efficiency increase.

Preferably, in the system of the first aspect of the present invention, the image accompanying information includes malignancy of an abnormal shadow candidate part.

According to the system, since it is possible to change displaying order of the image data to be image-diagnosed based on the malignancy of an abnormal shadow candidate part, for example, when doctor's diagnosis ability decreases due to his/her fatigue from image-diagnosing a large amount of image data, it is possible to determine the displaying order so as to diagnose from one having highest possibility of disease to lowest. Therefore, it is possible to minimize the doctor from making an oversight on disease.

Preferably, in the system of the first aspect of the present invention, the image accompanying information includes contrast of an abnormal shadow candidate part against a background image thereof.

According to the system, since it is possible to change displaying order of the image data to be image-diagnosed based on the contrast of an abnormal shadow candidate part against a background image thereof, for example, when doctor's diagnosis ability decreases due to his/her fatigue from image-diagnosing a large amount of image data, it is possible to determine the displaying order so as to diagnose from the most difficult one having low contrast to diagnose to the easiest one. Therefore, it is possible to minimize the doctor from making an oversight on disease.

Preferably, in the system of the first aspect of the present invention, the image accompanying information includes a diagnostic difficulty of the image data.

According to the system, since it is possible to change displaying order of the image data to be image-diagnosed based on the diagnostic difficulty, for example, when doctor's diagnosis ability decreases due to his/her fatigue from image-diagnosing a large amount of image data, it is possible to determine the displaying order so as to diagnose from on having the highest diagnostic difficulty to the lowest. Therefore, it is possible to minimize the doctor from making an oversight on disease.

Preferably, in the system of the first aspect of the present invention, the image accompanying information includes patient information of the subject.

According to the system, it is possible to change the displaying order of the image data to be image-diagnosed based on the level of disease possibility estimated from the patient information. For example, the disease possibility is calculated from patient's age, sex, medical history, smoking history, weight, life environment and the like. Since the disease possibility of the patient is estimated from information other than information of an abnormal shadow candidate detected by the abnormal shadow candidate detecting section, it is possible to increase diagnosis reliability.

Preferably, in the system of the first aspect of the present invention, the image accompanying information includes a radiographed part of the subject.

According to the system, it is possible to change the displaying order of the image data to be image-diagnosed based on the radiographed part. Therefore, it is possible to image-diagnose per each radiographed part such as chest, mamma, leg or the like, and thereby it is possible to contribute for diagnosis efficiency increase.

Preferably, in the system of the first aspect of the present invention, the input image data is a plurality of image data obtained by radiographing a plurality of subjects, or a plurality of image data obtained by radiographing the same subject at a plurality of times.

Preferably, the system of the first aspect of the present invention further comprises an image file database for storing an image file of the image data; and an image accompanying information database for storing image accompanying information accompanying the image data, wherein the image output selecting section determines the displaying order of the image data on the image display section based on the image accompanying information stored in the image accompanying information database, and outputs the image data by using the image file stored in the image file database.

According to the system, by dividing the image data into an image file having enormously large data amount, and image accompanying information having little data amount, it is possible to quickly determine the displaying order of the image data by only using the image accompanying information. Therefore, it is possible to reduce doctor's waiting time at the time of image diagnosis, and thereby it is possible to contribute for doctor's diagnosis efficiency increase.

In accordance with a second aspect of the present invention, an image diagnosis aid system comprises: an image storing section for storing input image data obtained by radiographing a plurality of subjects; an abnormal shadow candidate detecting section for detecting one or a plurality of kinds of abnormal shadow candidates per each of the plurality of subjects, and for generating abnormal shadow candidate information; an abnormal shadow candidate information storing section for storing the generated abnormal shadow candidate information with the corresponding image data related to the stored abnormal shadow candidate information; an image display section for displaying the stored image data, or the stored image data and the stored abnormal shadow candidate information; and an image output selecting section capable of changing displaying order of the image data in regard to the plurality of subjects on the image display section based on the abnormal shadow candidate information.

Preferably, in the system of the second aspect of the present invention, accompanying information corresponding to the image data to be displayed is input to the image output selecting section.

Preferably, in the system of the second aspect of the present invention, the image output selecting section determines the displaying order of the image data on the image display section based on both the image accompanying information and the abnormal shadow candidate information.

Preferably, in the system of the second aspect of the present invention, the image accompanying information includes malignancy of an abnormal shadow candidate part.

Preferably, in the system of the second aspect of the present invention, the image accompanying information includes contrast of an abnormal shadow candidate part against a background image thereof.

Preferably, in the system of the second aspect of the present invention, the image accompanying information includes a diagnostic difficulty of the image data.

Preferably, in the system of the second aspect of the present invention, the image accompanying information includes patient information of the plurality of subjects.

Preferably, in the system of the second aspect of the present invention, the image accompanying information includes radiographed parts of the plurality of subjects.

Preferably, in the system of the second aspect of the present invention, the image output selecting section determines the displaying order of the image data on the image display section based on existence of the abnormal shadow candidate information.

Preferably, the system of the second aspect of the present invention further comprises: an image file database for storing an image file of the image data; and an image accompanying information database for storing image accompanying information accompanying the image data, wherein the image output selecting section determines the displaying order of the image data on the image display section based on the image accompanying information stored in the image accompanying information database, and outputs the image data by using the image file stored in the image file database.

In accordance with a third aspect of the present invention, an image diagnosis aid method comprises: storing input image data obtained by radiographing a subject; detecting one or a plurality of kinds of abnormal shadow candidates from the stored image data; generating abnormal shadow candidate information; storing the generated abnormal shadow candidate information; changing displaying order of the stored image data based on the abnormal shadow candidate information; and displaying at least one of the stored image data and the stored abnormal shadow candidate information based on the changed displaying order.

Preferably, in the method of the third aspect of the present invention, the changing displaying order of the stored image data based on the abnormal shadow candidate information includes inputting image accompanying information corresponding to the image data to be displayed.

Preferably, in the method of the third aspect of the present invention, the changing displaying order of the stored image data based on the abnormal shadow candidate information includes determining the displaying order of the image data based on both the image accompanying information and the abnormal shadow candidate information.

Preferably, in the method of the third aspect of the present invention, the image accompanying information includes malignancy of an abnormal shadow candidate part.

Preferably, in the method of the third aspect of the present invention, the image accompanying information includes contrast of an abnormal shadow candidate part against a background image thereof.

Preferably, in the method of the third aspect of the present invention, the image accompanying information includes a diagnostic difficulty of the image data.

Preferably, in the method of the third aspect of the present invention, the image accompanying information includes patient information of the subject.

Preferably, in the method of the third aspect of the present invention, the image accompanying information includes a radiographed part of the subject.

Preferably, in the method of the third aspect of the present invention, the input image data is a plurality of image data obtained by radiographing a plurality of subjects or a plurality of image data obtained by radiographing the same subject at a plurality of times.

Preferably, the method of the third aspect of the present invention further comprises: storing an image file of the image data in an image file database; and storing image accompanying information accompanying the image data in an image accompanying information database, wherein the changing displaying order of the stored image data based on the abnormal shadow candidate information includes determining the displaying order of the image data based on the image accompanying information stored in the image accompanying information database, and outputting the image data by using the image file stored in the image file database.

In accordance with a fourth aspect of the present invention, an image diagnosis aid method comprising: storing input image data obtained by radiographing a plurality of subjects; detecting one or a plurality of kinds of abnormal shadow candidates from the stored image data for each of the plurality of subjects; generating abnormal shadow candidate information; storing the generated abnormal shadow candidate information with the corresponding image data related to the stored abnormal shadow candidate information; changing displaying order of the image data in regard to the plurality of subjects based on the abnormal shadow candidate information; and displaying the stored image data, or the stored image data and the stored abnormal shadow candidate information based on the changed displaying order.

Preferably, in the method of the fourth aspect of the present invention, the changing displaying order of the image data in regard to the plurality of subjects based on the abnormal shadow candidate information includes inputting image accompanying information corresponding to the image data to be displayed.

Preferably, in the method of the fourth aspect of the present invention, the changing displaying order of the image data in regard to the plurality of subjects based on the abnormal shadow candidate information includes determining the displaying order of the image data based on both the image accompanying information and the abnormal shadow candidate information.

Preferably, in the method of the fourth aspect of the present invention, the image accompanying information includes malignancy of an abnormal shadow candidate part.

Preferably, in the method of the fourth aspect of the present invention, the image accompanying information includes contrast of an abnormal shadow candidate part against a background image thereof.

Preferably, in the method of the fourth aspect of the present invention, the image accompanying information includes a diagnostic difficulty of the image data.

Preferably, in the method of the fourth aspect of the present invention, the image accompanying information includes patient information of the plurality of subjects.

Preferably, in the method of the fourth aspect of the present invention, the image accompanying information includes radiographed parts of the plurality of subjects.

Preferably, in the method of the fourth aspect of the present invention, the changing displaying order of the image data in regard to the plurality of subjects based on the abnormal shadow candidate information includes determining the displaying order of the image data based on existence of the abnormal shadow candidate information.

Preferably, the method of the fourth aspect of the present invention further comprises: storing an image file of the image data in an image file database; and storing image accompanying information accompanying the image data in an image accompanying information database, wherein the changing displaying order of the image data in regard to the plurality of subjects based on the abnormal shadow candidate information includes determining the displaying order of the image data based on the image accompanying information stored in the image accompanying information database, and outputting the image data by using the image file stored in the image file database.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a view showing a structure of an image diagnosis aid system according to the present invention,

FIG. 2A is a view showing an example of mass shadow,

FIG. 2B is a view showing an example of microcalcification clusters,

FIGS. 3A and 3B are views showing an example of an image accompanying information database, and

FIG. 4 is a flowchart explaining operation of the image diagnosis aid system.

### EMBODIMENTS OF THE INVENTION

Hereinafter, an embodiment of the present invention will be explained in detail with reference to figures.

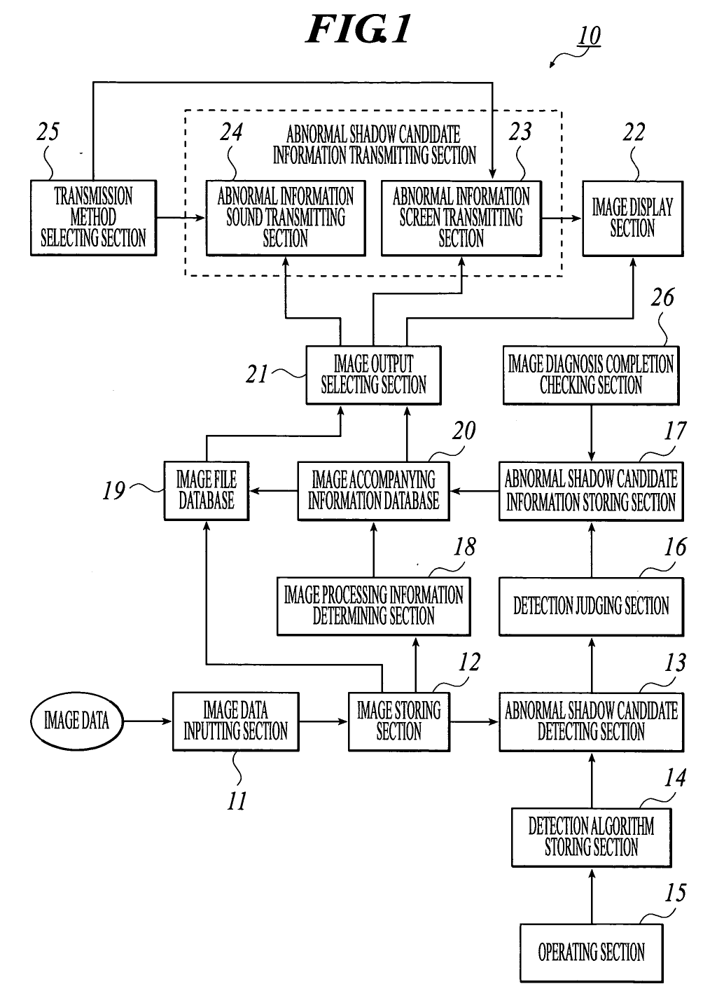

FIG. 1 shows a structure of an image diagnosis aid system 10 in the present embodiment.

As shown in FIG. 1, the image diagnosis aid system 10 comprises an image data inputting section 11, an image storage section 12, an abnormal shadow candidate detecting section 13, a detection algorithm storing section 14, an operating section 15, a detection judging section 16, an abnormal shadow candidate information storing section 17, an image processing information determining section 18, an image file database 19, an image accompanying information database 20, an image output selecting section 21, an image display section 22, an abnormal information screen transmitting section (abnormal shadow candidate information transmitting section) 23, an abnormal information sound transmitting section (abnormal shadow candidate information transmitting section) 24, a transmission method selecting section 25 and an image diagnosis completion checking section 26.

The image data inputting section 11 is to input digital image data, which is, for example, generated by scanning film in which a medical image is generated by radiographing a patient, measuring transmitted light volume and analog-digital-converting the measured volume by use of a laser digitizer. The image data inputting section 11 inputs a plurality of image data obtained from a plurality of patients at a group examination or the like. Further, image data input by the image data inputting section 11 may include a plurality of image data obtained from the same patient in a plurality of different times.

Further, the input by the image data inputting section 11 may be made not only with the above-mentioned laser digitizer, but also with an optical sensor such as CCD (Charge Coupled Device) or the like. In this case, film is light-scanned and its reflected light is photoelectrically converted by CCD for obtaining digital image data. Further, unlike the method of reading an image recorded in film, as disclosed in Japanese Patent Application Publication (Unexamined) Tokukai-Sho 55-12429, a radiography device capable of digitally converting a medical image radiographed with accumulative phosphor and outputting the medical image, may be connected and image data may be obtained from the radiography device. In this case, film is not necessary and therefore it is possible to reduce cost on the system.

Further, image data obtained from a Flat Panel Detector, which reads a radiation image with a plurality of detection devices arranged two-dimensionally and outputs the read radiation image as electric signals, may be input. For example, in Japanese Patent Application Publication (Unexamined) Tokukai-Hei 6-342098, disclosed is an art of generating electric charge corresponding to intensity of irradiated radiation, and accumulating the generated electric charge within a plurality of condensers arranged two-dimensionally.

Further, as written in Japanese Patent Application Publication (Unexamined) Tokukai-Hei 9-90048, a medical image may be input by generating fluorescence from radiation accumulated in a phosphor layer of intensifying screen or the like, and detecting intensity of the fluorescence by use of each pixel of photodetectors such as photodiodes. As other means to detect intensity of fluorescence, CCD or C-MOS (Complementary-Metal Oxide Semiconductor) sensor may be used. Further, a structure having a combination of radiation scintillators emitting visible light in response to radiation irradiation, and area sensors corresponding to lens array and each lens may be used as well.

Further, when a digital medical image is to be obtained with the above-mentioned various structures, though depending on a diagnosis purpose, in a case of mammogram for example, an effective pixel size of the image is preferably not more than 200 μm, more preferably not more than 100 μm. In order to bring out performance of the image diagnosis aid system 10 in the present invention to the utmost extent, for example, image data input with an effective pixel size of approximately 50 μm is preferably stored and displayed.

Further, when inputting image data, the image data inputting section 11 also inputs patient information regarding a radiographed patient, information regarding radiography and information regarding image data. Further, when outputting image data to the image storage section 12, the image data inputting section 11 also outputs these pieces of information correspondingly. Here, the patient information includes patient age, sex, medical history and the like. The information regarding radiography includes examination ID, examination type, radiography date, radiographed part, radiographic condition and the like. The information regarding image data includes the pixel number of the image data, sampling pitch, the bit number and the like.

Further, it is not necessary to have the image data inputting section 11. For example, image data may be read from various types of storage media such as CD-ROM (Compact Disc Read Only Memory) storing image data, floppy (registered trademark) disk or the like. Moreover, image data may be transmitted from an outer apparatus or PACS through network.

The image storing section 12 stores the image data input by the image data inputting section 11. The image storing section 12 applies data compression on the image data for storing it according to need. Here, as a method of the data compression, lossless or lossy compression using well-known JPEG (Joint Photographic Coding Experts Group), DPCM (Differential Pulse Code Modulation), wavelet transform compression or the like is used. Preferably, lossless compression, with which there is no deterioration on diagnosis information, is used.

The image storing section 12 is composed of a magnetic or optical storage medium or semiconductor memory. In a small-scale examination, since data amount input by the image data inputting section 11 is not too much, the image data can be stored in a magnetic disk without data compression applied on. In this case, it is possible to store and read the image data very fast compared to the case of using a magnetic optical disk. At the time of image-diagnosing an image, since fast cycle time is necessary, necessary image data is also stored in the semiconductor memory.

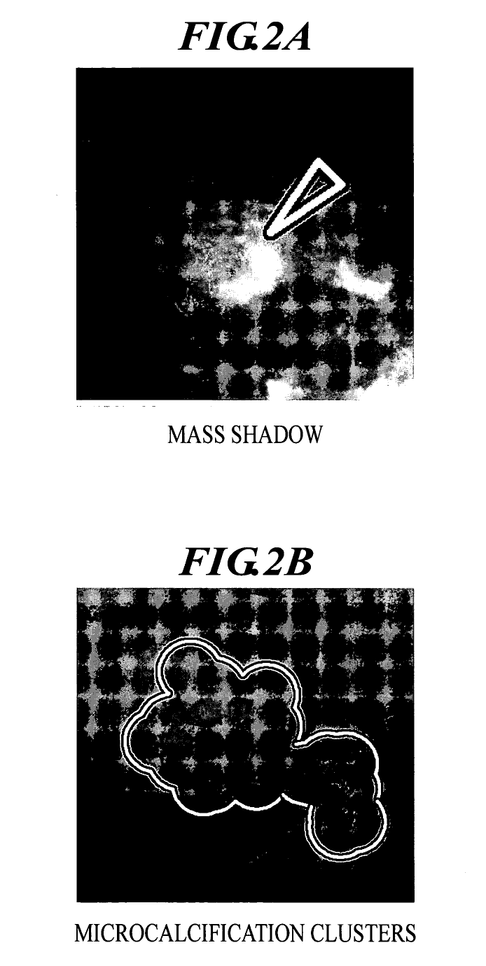

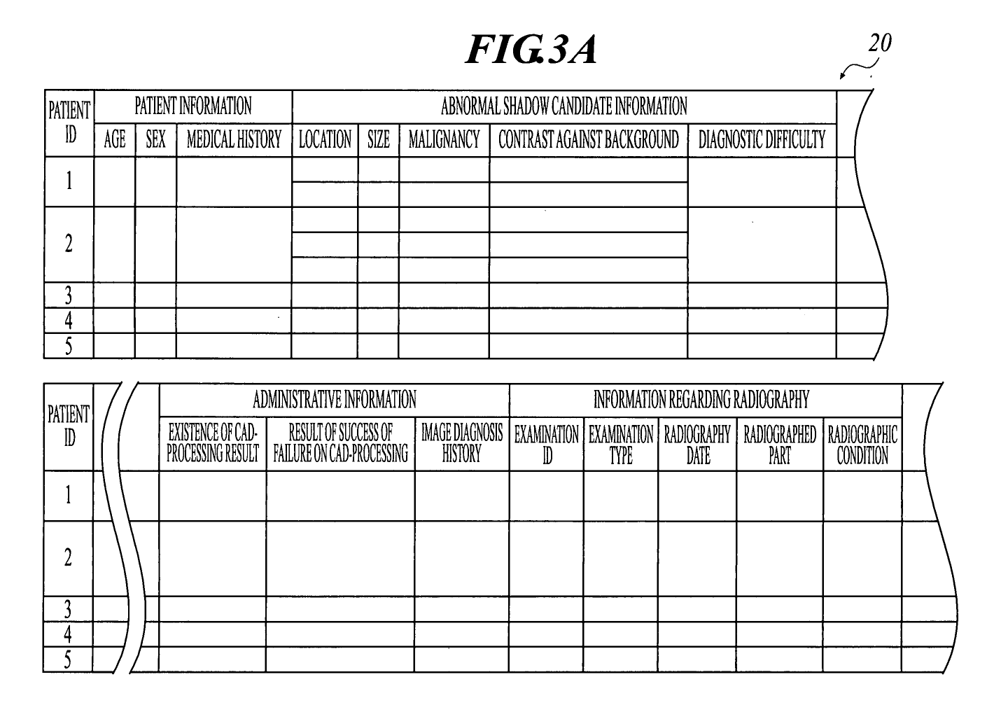

The abnormal shadow candidate detecting section 13 is composed of Computer Aided Diagnosis software (CAD). The abnormal shadow candidate detecting section 13 detects a candidate which is considered abnormal shadow such as mass shadow, microcalcification clusters or the like as shown in FIGS. 2A and 2B, by reading the image data from the image storing section 12 for image analysis. Mass shadow shown in FIG. 2A is seen as mass having a certain size, and whitish circular shadow being close to Gaussian distribution on mammogram. Further, an example of microcalcification clusters is shown in FIG. 2B. If gathered (clustered) microcalcification exists, there is a high possibility that the corresponding part is initial cancer. Therefore, it is one of the important findings for discovering early breast cancer. On mammogram, it is seen as whitish circular shadow having approximately circular conic structure.

As mentioned, as the two biggest findings of breast cancer, mass shadow and microcalcification can be cited. As a method to detect mass shadow, it is possible to use well-known detection methods written in the following theses:

(1) Mass Shadow

a detection method by comparing left and right mammas (Med.Phys.,Vol.21.No.3,pp.445-452)

a detection method by using Iris filter (IEICE transactions (D-II), Vol.J75-D-II,no.3,pp.663-670,1992)

a detection method by using Quoit filter (IEICE transactions (D-II), Vol.J76-D-II,no.3,pp.279-287,1993)

a detection method with binarization based on histogram of pixel values of divided mamma areas (Jamit Frontier lecture collected papers,pp.84-85,1995)

a minimum direction differential filter picking up minimum output from a large number of Laplacian filters having polarity (IEICE transactions (D-II), Vol.J76-D-II,no.2,pp.241-249,1993)

a method for distinguishing benignity or malignity of mass shadow by use of fractal dimensionality (Medical Imaging technologyl7(5),pp.577-584,1999)

Further, as a method to detect an abnormal shadow candidate of microcalcification clusters, it is possible to use well-known detection methods written in the following theses:

(2) Microcalcification Clusters

a method of deleting a false positive candidate in accordance with an optical density difference of shadow figure, standard deviation of a boundary density difference or the like, by localizing an area where there is a suspicion of calcification in a mamma area (IEEE Trans Biomed Eng BME-26(4):213-219,1979)

a detection method by using an image on which Laplacian filter processing is applied (IEICE transactions (D-II), Vol.J71-D-II,no.10,pp.1994-2001,1988)

a detection method using a morphologically analyzed image in order to inhibit a background pattern such as mammary gland or the like (IEICE transactions (D-II), Vol.J71-D-II,no.7,pp.1170-1176,1992)

Further, the abnormal shadow candidate detecting section 13 generates abnormal shadow candidate information based on the detected result. The abnormal shadow candidate information includes a position of an abnormal shadow candidate part, size, malignancy, contrast of the abnormal shadow candidate part against its background image, a diagnostic difficulty of image data or the like. The position of the abnormal shadow candidate part, the size, the malignancy, the contrast of the abnormal shadow candidate part against its background image are generated per each abnormal shadow candidate, and the diagnostic difficulty is generated by determining from the whole image data comprehensively.

The position of the abnormal shadow candidate part is indicated by a coordinate value of a gravity point in the abnormal shadow candidate part (for example, (x,y)=(100,1200) or the like). However, it may be a coordinate value indicating an image area of the abnormal shadow candidate part.

The size of the abnormal shadow candidate part is indicated by a size of an area which an image area of the abnormal shadow candidate part occupies. However, it may be an average distance or the longest distance from the gravity point in the abnormal shadow candidate part to a border thereof.

The malignancy of the abnormal shadow candidate part is calculated and digitized based on possibility of the abnormal shadow candidate being mass shadow or microcalcifitaion and benignity or malignity of detected mass shadow or microcalcification clusters.

The contrast of the abnormal shadow candidate part against its background image is indicated by a density difference between density of the abnormal shadow candidate part and that of its background image. However, it may be indicated by a brightness difference between brightness of the abnormal shadow candidate part and that of its background image.

The diagnostic difficulty is determined and digitized based on a position of each abnormal shadow candidate part, size, malignity, contrast against its background image and the like, comprehensively.

The above-mentioned processing, which the abnormal shadow candidate detecting section 13 performs for detecting an abnormal shadow candidate and generating abnormal shadow candidate information, is hereinafter called CAD-processing.

The detection algorithm storing section 14 stores a plurality of algorithms for the abnormal shadow candidate detecting section 13 to detect an abnormal shadow candidate. As the detection algorithm storing section 14, a hard disk device is used, for example.

The operating section 15 is to select at least one abnormal shadow candidate detection algorithm among the plurality of abnormal shadow candidate detection algorithms stored in the detection algorithm storing section 14. As the operation section 15, a keyboard is used, for example.

The detection judging section 16 judges whether the abnormal shadow candidate detecting section 13 has performed the CAD-processing successfully. There are some radiographic situations where a position of a radiographed part is significantly misaligned or there is not enough pressure on a mamma at the time of radiographing mammogram, and therefore the abnormal shadow candidate detecting section 13 cannot successfully perform the CAD-processing. The detection judging section 16 compares image data to a standard template to obtain their similarity. Successful performance of the CAD-processing is defined as when the similarity is more than a predetermined value.

The abnormal shadow candidate information storing section 17 stores the abnormal shadow candidate information generated by the abnormal shadow candidate detecting section 13, existence of CAD-processing result by the abnormal shadow candidate detecting section 13, result of success or failure on CAD-processing judged by the detection judging section 16 and an image diagnosis history input by a later-described image diagnosis completion checking section 26. The image diagnosis history is a history of image diagnosis on image data by a doctor.

The image processing information determining section 18 determines conditions regarding image processing to be applied on image data. The image processing includes gradation processing for converting to appropriate density and contrast for diagnosis by adjusting tone, frequency processing for adjusting sharpness of an image, rotating/inverting of an image and the like. The image processing information determining section 18 determines information regarding image processing such as gradation processing conditions, frequency processing conditions, image rotation/inversion conditions and the like.

The image file database 19 stores image files of image data by the image storing section 12. The image files are signal value data necessary for forming an image of the image data.

The image accompanying information database 20 stores image accompanying information. The image accompanying information is information accompanying image data.

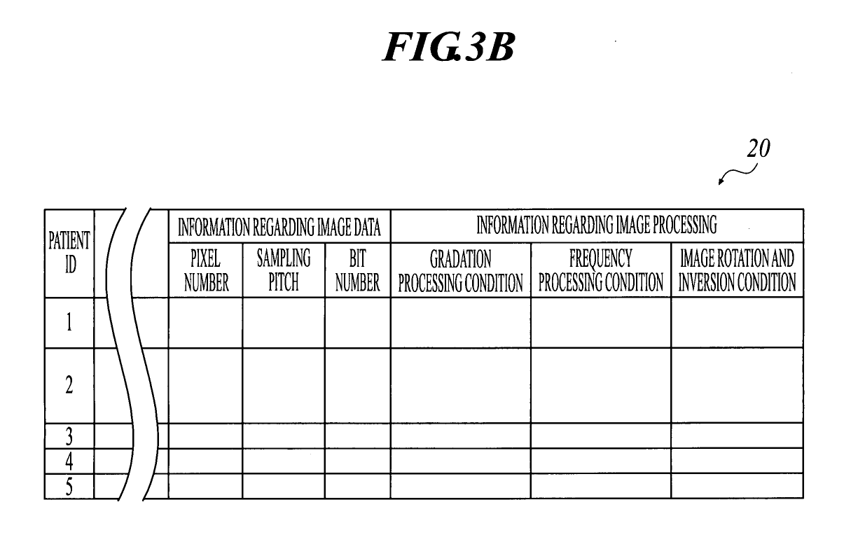

In FIGS. 3A and 3B, an example of the image accompanying information database 20 is shown.

As shown in FIGS. 3A and 3B, the image accompanying information comprises patient information, abnormal shadow candidate information, administrative information, information regarding radiography, information regarding image data and information regarding image processing.

The patient information, the information regarding radiography and the information regarding image data are stored in the image accompanying information database 20 by the image storing section 12. In FIGS. 3A and 3B, an example of storing age, sex and medical history as the patient information is illustrated. In addition, information such as smoking history, weight, life environment or the like may be stored. Further, as shown in FIGS. 3A and 3B, as the information regarding radiography, examination ID, examination type, radiography date, radiographed part and radiographic condition are stored in the image accompanying information database 20, and as the information regarding image data, pixel number of image data, sampling pitch and bit number are stored in the image accompanying information database 20.

The abnormal shadow candidate information is stored in the image accompanying information database 20 by the abnormal shadow candidate information storing section 17. In FIGS. 3A and 3B, an example of storing a location of an abnormal shadow candidate part, size, malignancy, contrast of the abnormal shadow candidate part against its background image and a diagnostic difficulty is illustrated. In addition, information such as shape of an abnormal shadow candidate part indicating a feature of an abnormal shadow candidate or clarity of its border or the like, may be stored.

The administrative information includes existence of CAD-processing result, result of success or failure on CAD-processing, image diagnosis history and the like, and is stored in the image accompanying information database 20 by the abnormal shadow candidate information storing section 17.

The information regarding image processing is stored in the image accompanying information database 20 by the image processing information determining section 18. In FIGS. 3A and 3B, an example of storing a gradation processing condition, a frequency processing condition and an image rotation/inversion condition is illustrated.

The image output selecting section 21 determines displaying order of image data to be displayed by the image display section 22 based on components of the image accompanying information database 20, applies image processing on the image data based on the information regarding image processing, and outputs an image file to the image display section 22 according to the determined displaying order. Further, the image output selecting section 21 outputs abnormal shadow candidate information corresponding to the image file to the abnormal information screen transmitting section 23 and/or the abnormal information sound transmitting section 24 according to the determined displaying order. The image output selecting section 21 includes an inputting means to input a selection of a standard to determine image displaying order. Here, a doctor makes a designation of the selection.

As a first image displaying order determining method, the image output selecting section 21 determines displaying order of the image data based on malignancy of an abnormal shadow candidate part. Since higher malignancy of an abnormal shadow candidate part needs to have more diagnosis importance, the displaying order is determined so as to make a diagnosis in the order of malignancy from highest to lowest.

As a second image displaying order determining method, the image output selecting section 21 determines displaying order of the image data based on contrast of an abnormal shadow candidate part against its background image. Since it is difficult to make a diagnosis when the contrast is low, the displaying order is determined so as to make a diagnosis in the order of contrast from lowest to highest.

As a third image displaying order determining method, the image output selecting section 21 determines displaying order of the image data based on diagnosis difficulties. Since it is difficult to make a diagnosis when the diagnostic difficulty is high, the displaying order is determined so as to make a diagnosis in the order of diagnosis difficulties from highest to lowest.

As a fourth image displaying order determining method, the image output selecting section 21 determines displaying order of the image data based on patient information. By calculating possibility of disease according to patient's age, sex, medical history or the like, the displaying order is determined so as to make the diagnosis in the order of possibility of disease from highest to lowest.

As a fifth image displaying order determining method, the image output selecting section 21 determines displaying order of the image data based on radiographed parts. The displaying order is determined so as to make a diagnosis per each radiographed part such as chest, mamma, leg or the like.

As a sixth image displaying order determining method, the image output selecting section 21 determines displaying order of the image data based on existence of abnormal shadow candidate information. The displaying order is determined so as to make a diagnosis in the order from the one either with or without abnormal shadow candidate information.

The image display section 22 displays the image data according to the displaying order determined by the image output selecting section 21. As the image display section 22, a display means such as a CRT, a liquid crystal display, a plasma display or the like can be used. In particular, most preferably, a high-definition high-intensity CRT or liquid crystal display for medical image use exclusively is used. Further, preferably a high-definition display having displaying pixels not less than 1000×1000 approximately is used, and furthermore, preferably a high-definition display having displaying pixels not less than 2000×2000 approximately is used.

In addition, the image display section 22 is capable of adjusting a display position of each displayed image, and inversing/rotating each displayed image. Therefore, it is possible to compare and investigate images from various aspects and therefore it is possible to make an easy, quick and accurate image diagnosis with medical images.

The abnormal information screen transmitting section 23 displays abnormal shadow candidate information on the image display section 22 for transmitting the abnormal shadow candidate information to a doctor. For example, the image display section 22 may comprise a multi-window system function capable of displaying a plurality of windows and displaying the abnormal shadow candidate information in a window other than a window displaying the image. Further, an abnormal shadow candidate part may be designated by a marker such as an arrow, a square (□), a triangle (Δ) or the like.

The abnormal information sound transmitting section 24 comprises a speaker or the like and outputs abnormal shadow candidate information as sound to be transmitted to a doctor. For example, a doctor is warned by a voice such as “There are three abnormal shadow candidates.” or the like.

The transmission method selecting section 25 selects a transmission method of abnormal shadow candidate information according to predetermined order. For example, a transmission method is selected by changing the order as abnormal information screen transmission section 23 → abnormal information sound transmission section 24 → both abnormal information screen transmission section 23 and abnormal information sound transmission section 24. The transmission method selecting section 25 includes a input means with which switching of transmission methods is designated. For example, a keyboard is used as the input means and pushing of a specific key switches transmission methods.

The image diagnosis completion checking section 26 inputs to an image displayed on the image display section 22, the information that a doctor has already image-diagnosed the image, and stores its image diagnosis history in the abnormal shadow candidate information storing section 17.

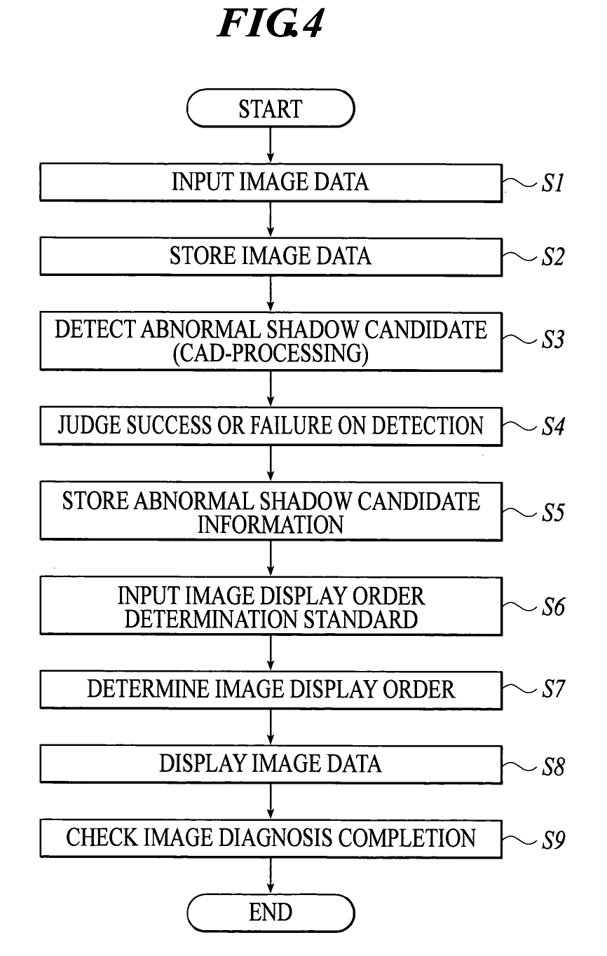

Hereinafter, with reference to FIG. 4, operation of the image diagnosis aid system 10 in the present embodiment will be explained.

In FIG. 4, first, image data obtained by radiographing a patient being a subject is input to the image diagnosis aid system 10 by the image data inputting section 11 (Step S1). The image data input by the image data inputting section 11 is stored in the image storing section 12 (Step S2). The stored image data is divided into an image file, patient information, information regarding radiography and information regarding image data by the image storing section 12. Then, the image file is stored in the image file database 19, the patient information, the information regarding radiography and the information regarding image data are stored in the image accompanying information database 20.

Next, the abnormal shadow candidate detecting section 13 loads the image data stored in the image storing section 12. Then the loaded image data is image-analyzed for detecting an abnormal shadow candidate (Step S3). The detection of an abnormal shadow candidate is performed according to an abnormal shadow candidate detection algorithm selected from the detection algorithm storing section 14 by the operating section 15. At this time, as the abnormal shadow candidate information, a position of the abnormal shadow candidate part, size, malignancy, contrast of the abnormal shadow candidate part against its background image and a diagnostic difficulty are generated.

Next, the detection judging section 16 judges whether CAD-processing by the abnormal shadow candidate detecting section 13 has been performed successfully or not (Step S4). Then, the abnormal shadow candidate information storing section 17 stores abnormal shadow candidate information generated by the abnormal shadow candidate detecting section 13, existence of CAD-processing result by the abnormal shadow candidate detecting section 13, and result of success or failure on CAD-processing judged by the detection judging section 16, and then they are stored in the image accompanying information database 20 (Step S5).

Next, determination standard of image displaying order determined by the image output selecting section 21 is input (Step S6). Based on the input determination standard of image displaying order, the image output selecting section 21 determines the image displaying order (Step S7). According to the determined image displaying order, image-processed image data is displayed on the image display section 22 (Step S8). At this time, abnormal shadow candidate information is transmitted by displaying it by use of the abnormal information screen transmitting section 23, by outputting it as sound by use of the abnormal information sound transmitting section 24, or by both displaying it and outputting it as sound. Switching of these abnormal shadow candidate information transmitting sections is performed by the transmission method selecting section 25 in accordance with predetermined order.

When a doctor completes image-diagnosing an image, the image diagnosis completion checking section 26 inputs the information that the doctor has already image-diagnosed the image, and its image diagnosis history is stored in the abnormal shadow candidate information storing section 17 (Step S9). The image diagnosis history is stored in the image accompanying information database 20 as administrative information.

As described above, since it is possible to change the displaying order of image data image-diagnosed according to a doctor's preference such as diagnosis importance, diagnosis difficulties or the like, it is possible to display the image data in the displaying order with which it is easy for a doctor to image-diagnose. Thereby, it is possible to contribute for diagnosis efficiency increase. Further, since displaying order of the image data is determined based on image accompanying information, it is possible to provide more detailed information at the time of image diagnosis. Especially, since there are cases where frequency of disease and the number of images to be image-diagnosed largely differ between a general practice and a group examination, by changing the displaying order of the image data to be image-diagnosed, it is possible to reduce doctor's fatigue and increase diagnosis accuracy over large amount of image data in a group examination.

For example, when doctor's diagnosis ability decreases due to his/her fatigue, it is possible to display image data in the order of malignancy from highest to lowest for the doctor to start image-diagnosing from the image data having high diagnosis importance, in the order of contrast from lowest to highest for the doctor to start image-diagnosing from the image data which is difficult to diagnose, or in the order of diagnosis difficulties judged by CAD-processing from highest to lowest for the doctor to image-diagnose. Accordingly, even when a large amount of image data is to be image-diagnosed, it is possible to minimize a doctor from making an oversight on disease.

Further, since it is possible to estimate disease possibility of a patient from patient information, which is different from abnormal shadow candidate information, and also it is possible to change the displaying order of image data to be image-diagnosed based on the level of disease possibility, it is possible to increase reliability on diagnosis.

Further, since it is possible to change the displaying order of image data to be image-diagnosed based on radiographed parts, it is possible to image-diagnose per each radiographed part such as chest, mamma, leg or the like at once. Thereby, it is possible to contribute for diagnosis efficiency increase.

Further, by dividing the image data into an image file having enormously large data amount, and image accompanying information having little data amount, it is possible to quickly determine the displaying order of image data by only using the image accompanying information. Accordingly, it is possible to reduce doctor's waiting time at the time of image diagnosis, and therefore it is possible to contribute for doctor's diagnosis efficiency increase.

Further, since it is possible to integrally manage existence of CAD-processing result, result of success or failure on CAD-processing and image diagnosis history, it is possible to easily obtain information necessary for a doctor who image-diagnoses an image. Thereby, it is possible to contribute for diagnosis efficiency increase.

Further, since it is possible to display abnormal shadow candidate information on a screen, transmit the abnormal shadow candidate information as sound, or transmit the abnormal shadow candidate information with both the methods, it is possible to transmit the abnormal shadow candidate information in a method with which it is easy for a doctor to use, and thereby it is possible to aid a doctor maintain his/her concentration. Accordingly, it is possible to increase detection accuracy of abnormal shadow.

In addition, determination standard of the image displaying order is not limited to the above-mentioned example, and it may be a combination of a plurality of standards. Further, in regard to the displaying order of image data, image diagnosis may proceed not in the order of importance from highest to lowest or in the order of difficulties from highest to lowest uniformly, but in the reverse order thereof, if a doctor gradually becomes used to diagnosis as the diagnosis proceeds. Further, for example, when a doctor needs to image-diagnose a large amount of image data and he/she will catch a rhythm on diagnosis in the middle, the displaying order may be selectable such as, the image diagnosis may start from image data which is easy to image-diagnose comparatively for a warm-up, or the like.

Further, in the present embodiment, in the transmission method selecting section 25, a keyboard is used as an input means to designate switching of transmission methods and pushing of a specific key switches the transmission methods of abnormal shadow candidate information. However, the transmission methods of abnormal shadow candidate information may be switched by using a pointing device such as a mouse or the like for selecting a button or the like displayed on the image display section 22. Further, an external switch may be placed for switching the transmission methods of abnormal shadow candidate information. Further, a barcode reading section may be placed for reading a barcode which identifies a doctor who image-diagnoses, for selecting an abnormal shadow candidate information transmitting section appropriate for the doctor.

Further, in the present embodiment, as an abnormal shadow candidate information transmitting means, the abnormal information screen transmitting section 23 and the abnormal information sound transmitting section 24 are placed, and the transmission method selecting section 25 selects screen display, sound output or both the screen display and the sound output by switching. However, abnormal shadow candidate information may be transmitted by the screen display, and only when malignancy is more than a predetermined value, the abnormal shadow candidate information is transmitted with the sound output. Further, as the abnormal shadow candidate information transmitting section, only the abnormal information sound transmitting section 24 may be placed, and abnormal shadow candidate information may be transmitted only with sound. In these cases also, since it is possible to transmit abnormal shadow candidate information with sound, it is possible to aid a doctor maintain his/her concentration, and thereby it is possible to contribute for diagnosis efficiency increase.

Further, the image diagnosis history may be distinguished by a case where image data is image-diagnosed along with abnormal shadow candidate information after CAD-processing, and a case image data as-is is image-diagnosed before CAD-processing. Further, the image diagnosis history may include not only whether an image has been image-diagnosed, but also a diagnosis result, a diagnosis date, a name of a person who image-diagnoses or the like.

Further, in the present embodiment, the patient information and the information regarding radiography are input along with image data by the image data inputting section 11. However, candidates of each information may be displayed with dialogue on the image display section 22 in order for a user to input appropriate information.

In addition, the description in the present embodiment is a suitable example of the image diagnosis aid system 10 regarding the present invention, and is not limited to the example.

And so forth, regarding the structure detail and the operational detail of each section composing the image diagnosis aid system 10 in the present embodiment, it is possible that various changes may be made without departing the gist of the present invention.

The entire disclosure of Japanese Patent Application No. Tokugan 2003-9102 filed on Jan. 17, 2003 including a specification, claims, drawings and summaries are incorporated herein by reference in their-entirety.

What is claimed is:

1. An image diagnosis aid system comprising:
an image storing section for storing input image data obtained by radiographing a subject;
an abnormal shadow candidate detecting section for detecting one or a plurality of kinds of abnormal shadow candidates from the stored image data, and for generating abnormal shadow candidate information;
an abnormal shadow candidate information storing section for storing the generated abnormal shadow candidate information;
an image display section for displaying at least one of the stored image data and the stored abnormal shadow candidate information; and
an image output selecting section capable of changing displaying order of the image data on the image display section based on the abnormal shadow candidate information.

2. The system of claim 1, wherein image accompanying information corresponding to the image data to be displayed is input to the image output selecting section.

3. The system of claim 2, wherein the image output selecting section determines the displaying order of the image data on the image display section based on both the image accompanying information and the abnormal shadow candidate information.

4. The system of claim 3, wherein the image accompanying information includes malignancy of an abnormal shadow candidate part.

5. The system of claim 3, wherein the image accompanying information includes contrast of an abnormal shadow candidate part against a background image thereof.

6. The system of claim 3, wherein the image accompanying information includes a diagnostic difficulty of the image data.

7. The system of claim 3, wherein the image accompanying information includes patient information of the subject.

8. The system of claim 3, wherein the image accompanying information includes a radiographed part of the subject.

9. The system of claim 1, wherein the input image data is a plurality of image data obtained by radiographing a plurality of subjects, or a plurality of image data obtained by radiographing the same subject at a plurality of times.

10. The system of claim 1 further comprising:
an image file database for storing an image file of the image data; and
an image accompanying information database for storing image accompanying information accompanying the image data,
wherein the image output selecting section determines the displaying order of the image data on the image display section based on the image accompanying information stored in the image accompanying information database, and outputs the image data by using the image file stored in the image file database.

11. An image diagnosis aid system comprising:
an image storing section for storing input image data obtained by radiographing a plurality of subjects;
an abnormal shadow candidate detecting section for detecting one or a plurality of kinds of abnormal shadow candidates per each of the plurality of subjects, and for generating abnormal shadow candidate information;
an abnormal shadow candidate information storing section for storing the generated abnormal shadow candidate information with the corresponding image data related to the stored abnormal shadow candidate information;
an image display section for displaying the stored image data, or the stored image data and the stored abnormal shadow candidate information; and
an image output selecting section capable of changing displaying order of the image data in regard to the plurality of subjects on the image display section based on the abnormal shadow candidate information.

12. The system of claim 11, wherein accompanying information corresponding to the image data to be displayed is input to the image output selecting section.

13. The system of claim 12, wherein the image output selecting section determines the displaying order of the image data on the image display section based on both the image accompanying information and the abnormal shadow candidate information.

14. The system of claim 13, wherein the image accompanying information includes malignancy of an abnormal shadow candidate part.

15. The system of claim 13, wherein the image accompanying information includes contrast of an abnormal shadow candidate part against a background image thereof.

16. The system of claim 13, wherein the image accompanying information includes a diagnostic difficulty of the image data.

17. The system of claim 13, wherein the image accompanying information includes patient information of the plurality of subjects.

18. The system of claim 13, wherein the image accompanying information includes radiographed parts of the plurality of subjects.

19. The system of claim 11, wherein the image output selecting section determines the displaying order of the image data on the image display section based on existence of the abnormal shadow candidate information.

20. The system of claim 11 further comprising:
an image file database for storing an image file of the image data; and
an image accompanying information database for storing image accompanying information accompanying the image data,
wherein the image output selecting section determines the displaying order of the image data on the image display section based on the image accompanying information stored in the image accompanying information database, and outputs the image data by using the image file stored in the image file database.

21. An image diagnosis aid method comprising:
storing input image data obtained by radiographing a subject;
detecting one or a plurality of kinds of abnormal shadow candidates from the stored image data;
generating abnormal shadow candidate information;
storing the generated abnormal shadow candidate information;
changing displaying order of the stored image data based on the abnormal shadow candidate information; and
displaying at least one of the stored image data and the stored abnormal shadow candidate information based on the changed displaying order.

22. The method of claim 21, wherein the changing displaying order of the stored image data based on the abnormal shadow candidate information includes inputting image accompanying information corresponding to the image data to be displayed.

23. The method of claim 22, wherein the changing displaying order of the stored image data based on the abnormal shadow candidate information includes determining the displaying order of the image data based on both the image accompanying information and the abnormal shadow candidate information.

24. The method of claim 23, wherein the image accompanying information includes malignancy of an abnormal shadow candidate part.

25. The method of claim 23, wherein the image accompanying information includes contrast of an abnormal shadow candidate part against a background image thereof.

26. The method of claim 23, wherein the image accompanying information includes a diagnostic difficulty of the image data.

27. The method of claim 23, wherein the image accompanying information includes patient information of the subject.

28. The method of claim 23, wherein the image accompanying information includes a radiographed part of the subject.

29. The method of claim 21, wherein the input image data is a plurality of image data obtained by radiographing a plurality of subjects or a plurality of image data obtained by radiographing the same subject at a plurality of times.

30. The method of claim 21 further comprising:
storing an image file of the image data in an image file database; and
storing image accompanying information accompanying the image data in an image accompanying information database,
wherein the changing displaying order of the stored image data based on the abnormal shadow candidate information includes determining the displaying order of the image data based on the image accompanying information stored in the image accompanying information database, and outputting the image data by using the image file stored in the image file database.

31. An image diagnosis aid method comprising:
storing input image data obtained by radiographing a plurality of subjects;
detecting one or a plurality of kinds of abnormal shadow candidates from the stored image data for each of the plurality of subjects;
generating abnormal shadow candidate information;
storing the generated abnormal shadow candidate information with the corresponding image data related to the stored abnormal shadow candidate information;
changing displaying order of the image data in regard to the plurality of subjects based on the abnormal shadow candidate information; and
displaying the stored image data, or the stored image data and the stored abnormal shadow candidate information based on the changed displaying order.

32. The method of claim 31, wherein the changing displaying order of the image data in regard to the plurality of subjects based on the abnormal shadow candidate information includes inputting image accompanying information corresponding to the image data to be displayed.

33. The method of claim 32, wherein the changing displaying order of the image data in regard to the plurality of subjects based on the abnormal shadow candidate information includes determining the displaying order of the image data based on both the image accompanying information and the abnormal shadow candidate information.

34. The method of claim 33, wherein the image accompanying information includes malignancy of an abnormal shadow candidate part.

35. The method of claim 33, wherein the image accompanying information includes contrast of an abnormal shadow candidate part against a background image thereof.

36. The method of claim 33, wherein the image accompanying information includes a diagnostic difficulty of the image data.

37. The method of claim 33, wherein the image accompanying information includes patient information of the plurality of subjects.

38. The method of claim 33, wherein the image accompanying information includes radiographed parts of the plurality of subjects.

39. The method of claim 31, wherein the changing displaying order of the image data in regard to the plurality of subjects based on the abnormal shadow candidate information includes determining the displaying order of the image data based on existence of the abnormal shadow candidate information.

40. The method of claim 31 further comprising:
storing an image file of the image data in an image file database; and
storing image accompanying information accompanying the image data in an image accompanying information database,
wherein the changing displaying order of the image data in regard to the plurality of subjects based on the abnormal shadow candidate information includes determining the displaying order of the image data based on the image accompanying information stored in the image accompanying information database, and outputting the image data by using the image file stored in the image file database.
